(19) United States
(12) Patent Application Publication
(10) Pub. No.: US 2005/0279690 A1
(43) Pub. Date: Dec. 22, 2005

(54) High concentration electrolised ozonated water generation system

(76) Inventor: Maxwell Hsu, Tao-Yuan (TW)

Correspondence Address: Yi-Wen Tseng, 4331 Stevens Battle Lane, Fairfax, VA, 22033, US

(21) Appl. No.: 10/871,561

(22) Filed: Jun. 21, 2004

(51) Int. Cl. C02F 1/78; C02F 9/00; C02F 9/02

(52) U.S. Cl. 210/205; 210/760

(57) ABSTRACT

A high concentration electrolised ozonated water generation system is capable of converting input water provided by a public water system into high concentration electrolised ozonated water, which includes a first filter, a second filter, a pure water tank, an ozone generator, a gas-water mixer, and a switch. The first filter eliminates the residual chlorine, heavy metal elements, and bacteria from the preliminary clean water, and thereby produces clean water. The second filter eliminates the anions and cations from the clean water, and thereby produces pure water. The pure water is transported to and stored in the pure water tank. When the system proceeds the pure water generation, the ozone generator receives the pure water from the pure water tank and produces a mixture of ozone, oxygen and water and outputs the mixture to the pure water tank. When the switch is engaged, the input water is conveyed to the gas-water mixer. The ozone gas flows to the gas-water mixer via a gas pipeline. The gas-water mixer mixes the input water and the ozone gas, and thereby produces the high concentration electrolised ozonated water.

### BACKGROUND OF THE INVENTION

The present invention relates in general to a high concentration electrolised ozonated water generation system, and more particularly, to a high concentration electrolised ozonated water generation system capable of converting source water provided by a public water system into high concentration electrolised ozonated water.

The human body benefits materially from clean water. But the water from a public water system is of low quality since the water becomes contaminated while on its way to homes for consumption. The water becomes contaminated because it is conveyed to the homes through old and deteriorated plumbing. Today people are more concerned with the quality of their water because of their higher standard of living. Moreover, the health effect of using water from public water systems to rinse food, among other things, has also become a concern for many people. These concerns are justified because the processing of source water from a public water system consists of nothing more than a series of sequenced filtrations to remove debris from the water, with the addition of chlorine to sanitize the water. However, after the processed water from a public water system has arrived at a consumer's home, it has again become impure. In an effort to clean the water again, many consumers boil the water they receive. But boiling does little to actually improve the quality of the water received from the public water system. Therefore, the quality of the water people drink remains the from the time they receive it in their homes.

Ozone has shown itself to be an extremely useful tool in improving the quality of the drinking water that people consume such that has been gradually accepted by most consumers today as a much better method of killing bacteria than the conventional method of adding chlorine to water. Ozone has three Oxygen atoms and is rather unstable. Because Ozone is unstable it is easy for Ozone to oxidize other elements. By utilizing this oxidation Ozone can kill bacteria immediately, dissolve pesticides, remove foul odors, and disinfect. However, conventional ozonated water generator usually utilizes electric discharges of high voltage to produce ozone gas. Due to the air containing only 21% oxygen but 78% nitrogen, the produced ozone is not complete.

### BRIEF SUMMARY OF THE INVENTION

The present invention provides a high concentration electrolised ozonated water generation system capable of converting source water provided by a public water system into high concentration electrolised ozonated water.

The high concentration electrolised ozonated water generation system provided by the present invention includes a first filter, a second filter, a pure water tank, an ozone generator, a gas-water mixer, and a water delivery switch. The first filter utilizing electrochemical oxidation-reduction reaction eliminates the residual chlorine, heavy metal elements, and bacteria from the preliminary clean water. The second filter utilizing ion exchange resin eliminates the anions and cations from the clean water and thereby produce deionized pure water. The pure water is further transported to and stored in the pure water tank. When the system proceeds the pure water generation, the ozone generator receives the pure water from the pure water tank and produces a mixture of ozone, oxygen and water and outputs the mixture to the pure water tank via a pipeline.

When the water delivery switch is engaged, the preliminary clean water from an external filter will be conveyed to the gas-water mixer. The ozone gas stored in the pure water tank flows to the gas-water mixer via a gas pipeline. The gas-water mixer mixes the preliminary clean water and the ozone gas, and thereby produces high concentration electrolised ozonated water.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

These as well as other features of the present invention will become more apparent upon reference to the drawings therein:

FIG. 1 is a system diagram of a high concentration electrolised ozonated water generation system in accordance with one embodiment of the present invention;

FIG. 2 is a schematic flow diagram of a high concentration electrolised ozonated water generation system illustrating the operating procedures; and

FIG. 3 is a perspective view of a high concentration electrolised ozonated water generation system fully assembled.

### DETAILED DESCRIPTION OF THE INVENTION

Reference will now be made in detail to the preferred embodiments of the present invention, examples of which are illustrated in the accompanying drawings. Wherever possible, the same reference numbers are used in the drawings and the description to refer to the same or like parts.

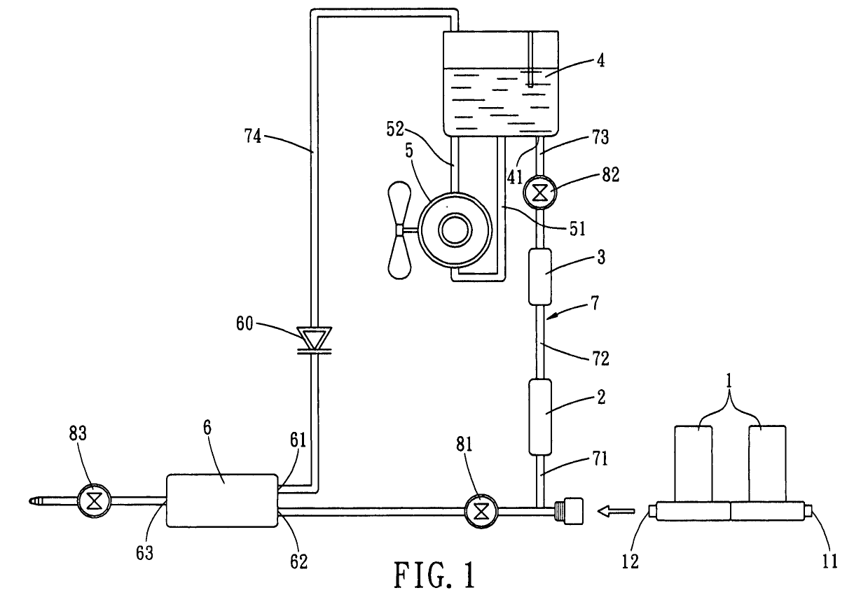

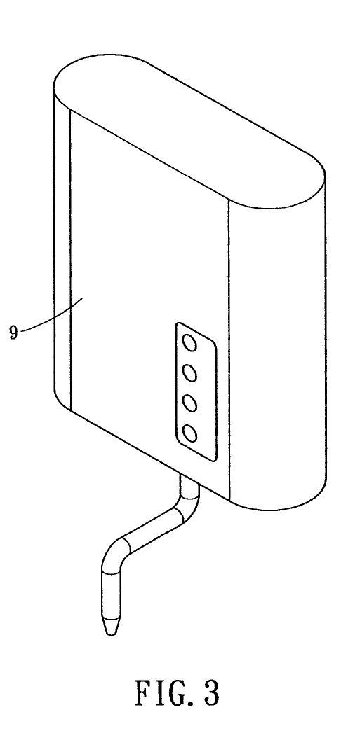

FIG. 1 shows a high concentration electrolised ozonated water generation system which includes a first filter 2, a second filter 3, a pure water tank 4, an ozone generator 5, a gas-water mixer 6, pipelines 7, and a plurality of switches 81, 82 and 83. Moreover, before entering the high concentration electrolised ozonated water generation system, the source water has to be filtered by an external filter 1. All the components of the present invention except the external filter 1 are enclosed in a shell 9, as illustrated in FIG. 3.

The external filter 1 connects to the external hoses through a water inlet 11 in order to receive the source water, such as tap water generated from the public water system. By utilizing its PP (polypropylene) filter cartridge and its ceramic filter cartridge the external filter 1 can effectively eliminate planktons, bacteria, chlorides and other large molecule impurities from the source water. In another example, an activated carbon filter cartridge or other antibiotic filter cartridges can be used in the external filter 1. A water outlet 12 of the external filter 1 is connected to the first filter 2 and a first switch 81 via a pipeline 71. Normally the preliminary clean water generated by the external filter 1 is transported to the first filter 2.

The first filter 2 includes a filter cartridge containing copper ions, zinc ions, and activated carbon ions. The main function of the first filter 2 is to further eliminate the residual chlorine, heavy metal elements, and bacteria from the entering preliminary clean water received from the external filter 1.

The second filter 3 connects to the first filter 2 via a pipeline 72. The second filter 3 can eliminate the anions and cations of the clean water from the first filter 2 in order to obtain a high purity deionized water called pure water.

The pure water tank 4 stores the pure water generated by the second filter 3 and the ozone gas generated by the ozone generator 5. The pure water tank 4 connects to the second filter 3 via a pipeline 73. A second switch 82 is installed in the pipeline 73 to control the conveying of the pure water generated by the second filter 3.

The ozone generator 5 has an electrolytic cell which can splits water into its basic elements and then convert part of the liberated oxygen into ozone. The ozone generator 5 receives the pure water via the pipeline 51. The ozone generator 5 outputs the mixture of ozone, oxygen and water to the pure water tank 4 via a pipeline 52. The ozone gas stored in the pure water tank 4 can flow to the gas-water mixer 6 via the pipeline 74.

The gas-water mixer 6 mixes the source water from the external filter 1 with the ozone gas from the pure water tank to produce the high concentration electrolised ozonated water. A water inlet 62 of the gas-water mixer 6 connects to the external filter 1 under the control of the first switch 81. The gas inlet 61 of the gas-water mixer 6 connects to the pure water tank 4 via the pipeline 74, in which a check valve 60 is installed, to acquire the ozone gas. The gas-water mixer 6 outputs the high concentration electrolised ozonated water via a water outlet 63. The third switch, that is a water delivery switch 83 controls the output of the high concentration electrolised ozonated water.

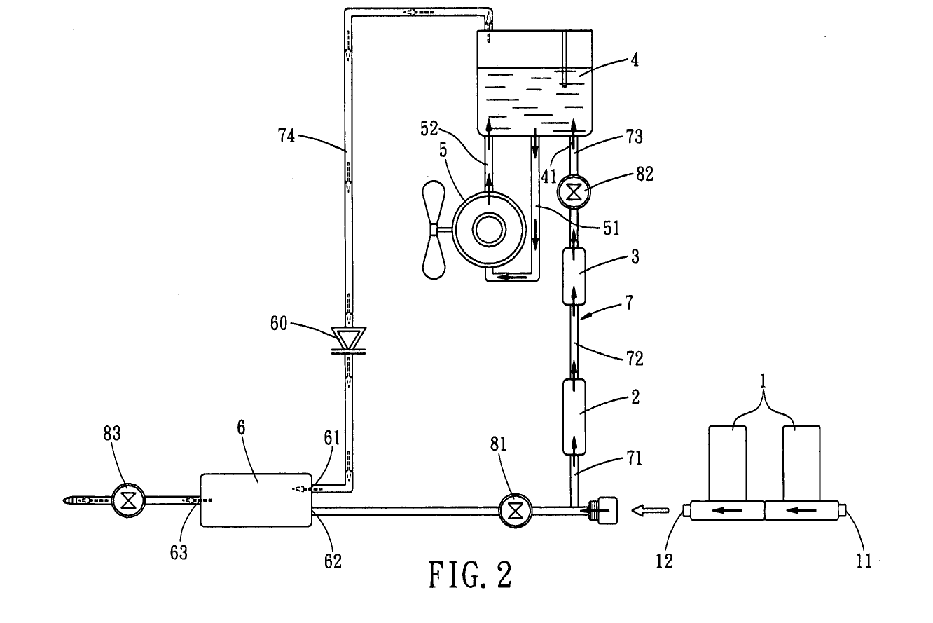

The actual operation of the high concentration electrolised ozonated water generation system is illustrated in FIG. 2. Before entering the high concentration electrolised ozonated water generation system, the source water has to be filtered by the external filter 1. The external filter 1 can effectively eliminate planktons, bacteria, chlorides and other large molecule impurities from the source water. After the treatment by the exterior filter 1, the source water becomes preliminary clean water. At this time, the first switch 81 between the external filter 1 and the gas-water mixer 6 is closed. Therefore, the preliminary water from the external filter 1 is directed to the first filter 2. The first filter 2 utilizing electrochemical oxidation-reduction reaction eliminates the residual chlorine, heavy metal elements, and bacteria from the preliminary clean water which arrived from the external filter 1. After the treatment by the first filter 2, the preliminary clean water becomes clean water.

Furthermore, the clean water is delivered to the second filter 3. The second filter 3 can eliminate the anions and cations from the clean water. The deionized water obtained is called pure water. The pure water is further transported to and stored in the pure water tank 4. Certainly, if the pure water tank is full of pure water, the second switch 82 will be shut off so that no more pure water flows to the pure water tank 4.

When the system proceeds the pure water generation, the ozone generator 5 receives the pure water via the pipeline 51. The ozone generator produces a mixture of ozone, oxygen and water and outputs the mixture to the pure water tank 4 via the pipeline 52.

When the consumer needs the high concentration electrolised ozonated water, he engages the water delivery switch 83. Under the engagement of the water delivery switch 83, the first switch 81 is opened, and the preliminary clean water is directed from the external filter 1 to the gas-water mixer 6. Meanwhile, the ozone gas stored in the pure water tank 4 flows to the gas-water mixer 6 via the gas pipeline 74. The gas-water mixer 6 mixes the preliminary clean water and the ozone gas, and thereby produces the high concentration electrolised ozonated water.

While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

1. A high concentration electrolised ozonated water generation system for converting input water into high concentration electrolised ozonated water, comprising:
a first filter for receiving the input water to output clean water;
a second filter connected to the first filter for receiving the clean water to output pure water;
a water tank connected to the second filter for storing the pure water;
an ozone generator connected to the water tank for converting the pure water into ozone, oxygen, water mixture;
a gas-water mixer connected to the water tank for mixing the ozone gas with the input water, and thereby producing the high concentration electrolised ozonated water; and
a third switch controlling the output of the high concentration electrolised ozonated water.

2. The high concentration electrolised ozonated water generation system of claim 1, further comprising a first switch to be opened for delivering the input water to the gas-water mixer when the third switch is opened.

3. The high concentration electrolised ozonated water generation system of claim 1, wherein the first filter eliminates residual chlorine, heavy metal elements, and bacteria from the input water.

4. The high concentration electrolised ozonated water generation system of claim 1, wherein the second filter eliminates anions and cations from the clean water.

5. The high concentration electrolised ozonated water generation system of claim 1, wherein the gas-water mixer includes a water inlet connected to a first pipeline in which a first switch is installed, for receiving the input, a gas inlet connected to a second pipeline in which a check valve is installed, for receiving the ozone gas from the water tank, and a water outlet connected to a third pipeline in which the third switch is installed.
